(19) United States
(12) Patent Application Publication
(10) Pub. No.: US 2016/0281314 A1
(43) Pub. Date: Sep. 29, 2016

(54) Stretch Dam

(71) Applicant: Shahriar Eftekharzadeh, Torrance, CA (US)

(72) Inventor: Shahriar Eftekharzadeh, Torrance, CA (US)

(21) Appl. No.: 15/179,956

(22) Filed: Jun. 10, 2016

(51) Int. Cl. E02B 3/10; F15B 15/10; F15B 15/14; F15B 15/26; E02B 7/40; E02B 7/44

(52) U.S. Cl. CPC E02B 3/10; E02B 7/40; E02B 7/44; F15B 15/14; F15B 15/26; F15B 15/10

(57) ABSTRACT

A power operated moveable gate barricade comprised of individual wicket gate devices wrapped and sealed inside a stretchable elastomer.

### FIELD OF THE INVENTION

The present invention relates to power operated moveable gates and more specifically to improvements thereto for making such gates less susceptible to external elements. More specifically, the present invention relates to making moveable gates suitable for deployment along river banks and onshore in coastal areas to protect against flooding and sea level rise.

### BACKGROUND OF THE INVENTION

Many coastal areas require protection against flooding during high tides, storms and hurricanes or in the case of a Tsunami. Sea level rise due to global warming is increasing the frequency of coastal flooding, particularly in low coastal and flat beach areas. Similarly, many developed areas in river floodplains require protection from flooding during high flows. Various types of barricades are used to protect coastal areas and floodplains from flooding. These are either permanent structures in the form of floodwalls, seawalls, dikes, and levees, or are temporary barricades such as sand bags or other portable barriers in various shapes, forms, and materials.

Conventional flood protection barriers in the art are stationary above-ground structures that create visual obstruction and restrict access to and from the seafront, which makes them infeasible in populated low lying and flat beach areas where flood protection is needed most. Temporary flood protection structures have limited application, long response time, and entail significant effort and cost for deployment. Therefore, protection of populated low lying and flat coastal areas against impacts of sea level rise requires some form of a permanent moveable barricade that is normally in retracted position at or marginally below ground level to permit access, and rises above ground to provide protection only when needed.

Movable gate barricades are common in the art and are utilized not as seawalls or flood dikes, but as water level control gates to maintain or regulate a pool of water upstream of a dam by being raised to maintain maximum pool or lowered to pass flow. Movable barricades are also utilized to provide a navigable pass in the form of hydraulically or pneumatically operated wicket gates in inland water ways. Current hydraulically or pneumatically operated wicket gates in the art are not capable of shoreline protection because the operation of their exposed gates, struts, and gate panels would be fatally hampered by the sand and debris that is prevalent in such environments. Also, current moveable barricades and supporting structures reside above ground at all times even when retracted and thus obstruct access to and from the water front.

There have been some effort to isolate and protect the operating systems of movable barricades from the elements. U.S. Pat. No. 5,199,812 (the '812 patent) teaches a hydraulically operated wicket gate moveable barricade, in which the wicket gates are operated by hydraulic and electrical equipment from within a dry gallery which isolates and protects the equipment from external elements. However, the '812 patent does not isolate the wicket gates and the struts that support the wicket gate from the elements and leaves the downstream side of the wicket gate exposed and prone to debris accumulation that would obstruct the lowering of the wicket gate if deployed for flood protection in a coastal or river bank environment. Also, the dry gallery of the '812 patent requires extensive civil construction that is not compatible with the extensive length of moveable barricade needed for shoreline protection. Furthermore, the wicket gate plus part of the dry gallery reside above ground at all times, and would thus obstruct access to and from the seafront. U.S. Pat. No. 5,433,555 (the '555 patent) provides an oscillating jack with chamber sealing in the sill of the dam to prevent the intrusion of debris and silt. Similarly, the '555 patent leaves the wicket gate and the jack exposed and prone to debris and silt accumulation on the downstream side of the wicket gate, thus making it unsuitable for shoreline protection. U.S. Pat. No. 5,538,360 (the '360 patent) discloses an inflation control system for a crest gate having movable panels controlled in position by inflatable bladders. The system in the '360 patent is better protected from the elements because of its inflatable operating system, but is not feasible for shoreline protection because of susceptibility of the gate incomplete lowering due to accumulation debris underneath the gate panel downstream, as well as it residing above ground.

Therefore, there is a need for a moveable barricade that is not susceptible to external elements such as sand and debris during operation. Such a device can be constructed underground parallel to the shoreline to permit unobstructed access when in lowered position, but can be rapidly raised to protect against flooding without being prone to sand and debris accumulation hampering or preventing its operation.

### SUMMARY OF THE INVENTION

The present invention provides an answer to the above stated need with a moveable gate barricade comprised of individual wicket gate devices wrapped and sealed inside a stretchable elastomer. The elastomer stretches as the wicket gate is raised shielding the wicket gate components from the elements, and contracts back with the lowering of the wicket gate. The wicket gate panel along with all other components are sealed inside the elastomer, which is stretched by the wicket gate as it is raised covering over the void on the backside of the gate thus prevents external objects and debris from interfering with the operation of the gate. The stretched elastomer gives the raised gate device a triangular cross sectional shape with the ground surface as the base, the gate surface as the upstream side, and the stretched taught elastomer as the downstream side. The fully lowered gate resides horizontally just below the ground surface and the raising of the gate stretches the elastomer and creates the triangular cross section, with the slopes of the upstream and downstream sides changing to their final degrees as the gate reaches is maximum height.

The moveable gate barricade is constructed by placing a plurality of individual wicket gate devices side by side to form the desired length of the barricade. The individual wicket gate devices may be made from either metal, concrete, or plastic, each with its wicket gate hinged at one end serving as the flip-open lid of that device. Each wicket gate device has its own operating system, which may be hydraulic or pneumatic. If hydraulic, the control system may be comprised of hydraulic cylinder and associated electric motor hydraulic pump and oil reservoir for that unit. If pneumatic, the control system may use an inflatable bladder system similar to the '360 patent. The stretchable elastomer may be incorporated onsite by wrapping the wicket gate devices inside sheets of elastomer, or the wicket gate devices may be pre-fabricated with the stretchable elastomer, either individually or in groups. Either way, the wicket gate devices or groups of devices are placed side by side and adjoined at the seams of adjacent elastomers, fastened to anchors inside a shallow trench, and covered over by native soil such that the fully lowered barricade reside marginally below ground.

In one embodiment of the present invention, the individual wicket gates are operated with a pneumatic system, while in another embodiment the wicket gates are operated with a hydraulic system. In the embodiment using a pneumatic operating system, the wicket gate device of the present invention is fitted with an inflatable bladder and the gate is raised and lowered by controlling the inflation pressure of the bladder via a pressurized air tube. The pneumatic operating system may use a common pressure tube to simultaneously provide pressurized air to the plurality of wicket gate devices. Alternatively, the individual wicket gate devices may be fitted with air pumps operated by remotely supplied electrical current.

In the embodiment using a hydraulic control system, the wicket gate device of the present invention contains an electrical motor, hydraulic pumps, and oil reservoir coupled to a hydraulic cylinder and piston. There is a strut hinged at the underside of the wicket gate at one end, and to wheels running on horizontal rails on the floor of the device at the other end. There is a horizontally mounted hydraulic cylinder and piston with a rod attached to the wheels that moves them back and forth to raise and lower the wicket gate. The horizontal mounting of the hydraulic cylinder minimizes the vertical dimension of the wicket gate device. The wheels are equipped with a locking mechanism that secures them in place at predetermined angular positions allowing the gate to stay raised with the power turned off. The locking mechanism snaps to unlocked position once the gate is raised passed its maximum height to permit lowering of the gate, and snaps back to locking position once the gate is fully closed. Power for all modules is supplied with an external electrical cord.

It is an object of this invention to provide a permanent moveable barricade substantially parallel to the shoreline and normally in retracted position enabling unobstructed access, capable of being rapidly raised to provide shoreline protection without being prone to sand and debris interfering with barricade operation.

It is an object of this invention to provide improved elements and arrangements by apparatus for the purposes described thereof, which is comparable in cost with existing systems, dependable, and fully effective in accomplishing its intended purposes.

These and other objects of the present invention will become readily apparent upon further review of the following specification and drawings.

### BRIEF DESCRIPTION OF THE DRAWINGS

FIG. 1 shows a cross sectional view of the wicket gate device of the present invention using hydraulic operating system with the wicket gate in fully raised position.

FIG. 2 shows a cross sectional view of the wicket gate device of the present invention using hydraulic operating system with the wicket gate in fully lowered position.

FIG. 3 shows a cross sectional view of the wicket gate device of the present invention using hydraulic operating system with the wicket gate raised about one third of the way to the fully raised position.

FIG. 4 shows a cross sectional view of the wicket gate device of the present invention using hydraulic operating system with the wicket gate raised about two thirds of the way to the fully raised position.

FIG. 5 is a perspective view of the wicket gate raising and lowering mechanism using hydraulic operating system.

FIG. 6 provides details of the wicket gate locking mechanism using hydraulic operating system with the wicket gate in fully lowered position.

FIG. 7 provides details of the wicket gate lock release mechanism using hydraulic operating system with the wicket gate in fully raised position.

FIG. 8 provides details of the wicket gate lock re-engagement mechanism using hydraulic operating system with the wicket gate in fully lowered position.

FIG. 9 is a perspective view of a typical construction site for the present invention using hydraulic operating system showing the various elements of the present invention.

FIG. 10 shows the completed construction site with the present invention in place and the moveable gate barricade in fully lowered position.

FIG. 11 shows the present invention in place and the moveable gate barricade in partially raised position using hydraulic operating system.

FIG. 12 shows the present invention in place and the moveable gate barricade in fully raised position using hydraulic operating system providing flood protection against elevated water level.

FIG. 13 shows a cross sectional view of the wicket gate device of the present invention using pneumatic operating system without air pump with the wicket gate in fully raised position.

FIG. 14 shows a cross sectional view of the wicket gate device of the present invention using pneumatic operating system with air pump with the wicket gate in fully raised position.

### DETAILED DESCRIPTION

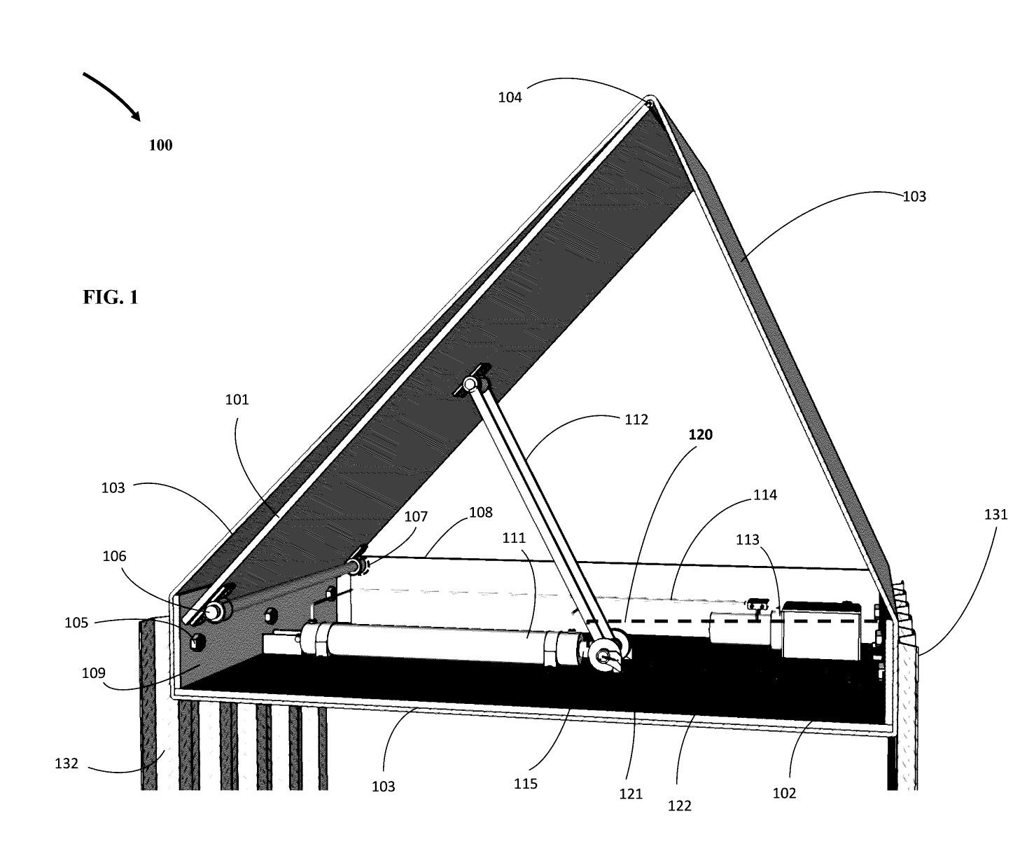

Referring to FIG. 1, there is shown a cross sectional view of an individual wicket gate device of one embodiment of the present invention using hydraulic operating system 100 with wicket gate 101 in fully raised position. Wicket gate device of the present invention 100 is comprised of structural box 102 made from metal, concrete, or plastic, having a wicket gate 101 mounted on rod 106 that spans the width of box 102 supported at either end by bearings 107 in sides 108 near the top corner adjacent to upstream end 109, with wicket gate 101 serving as the flip-open lid of box 102. Wicket gate device box 102 is fitted with a hydraulic control system containing the hydraulic cylinder 111 and associated electric motor hydraulic pump and oil reservoir 113 and hydraulic piping 114 for that module. Stretchable elastomer 103 forms an impermeable cover over the air gaps between stationary and moveable components of each module as well as the air gaps between adjacent modules, thus sealing and protecting against external elements. The raising of gate 101 exerts a tensile force on elastomer 103 at roller 104 on the unhinged end of wicket gate 101, which uniformly stretches elastomer 103. Fasteners 105 secure structural box 102 to anchors such as sheet piles 132 and 131 on both upstream and downstream sides. The hydraulic operation of gate 101 is accomplished by the horizontally mounted two-way hydraulic cylinder 111 moving piston rod 115 connected to wheels 121 running on horizontal rails 122 to raise and lower gate 101 by means of strut 112 hinged at wheels 121 on one end and to underside of gate 101 at the other end. Tension in elastomer 103 maintains positive downward force on wheels 112 at all times during operation preventing vibrations and derailment.

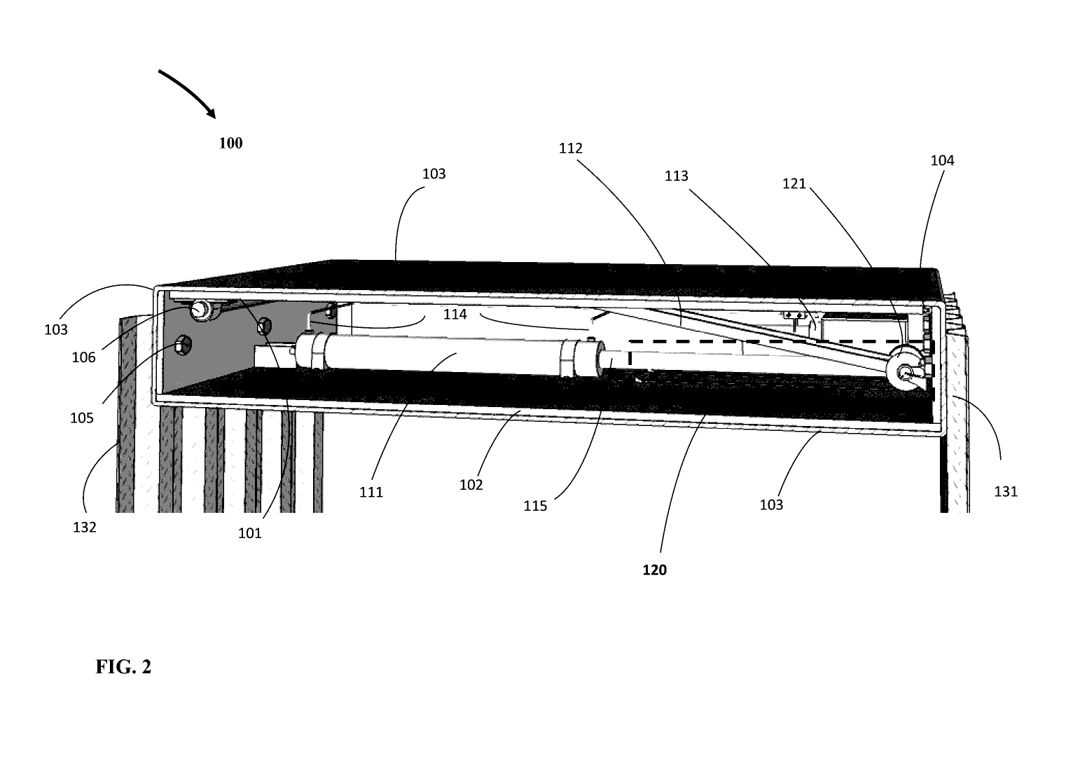

FIG. 2 shows a cross sectional view of an individual wicket gate device of present invention 100 with gate 101 in fully lowered position. The fully lowered position of gate 101 closes the lid on wicket gate device box 102 and allows elastomer 103 to fully contract while maintaining its tight grip around the outside surface of wicket gate device box 102 and gate 101. Elastomer 103 fully seals box 102, gate 101 and all equipment inside from external elements. In the fully lowered position shown in FIG. 2, gate 101 rests on structural box 102 and is supported on at least two sides such that it is capable of supporting heavy loads imposed by soil and traffic above. Accordingly, ground anchors 131 and 132, and fasteners 105 are designed for the static and dynamic loads from soil and traffic above when wicket gate 101 is in fully lowered position.

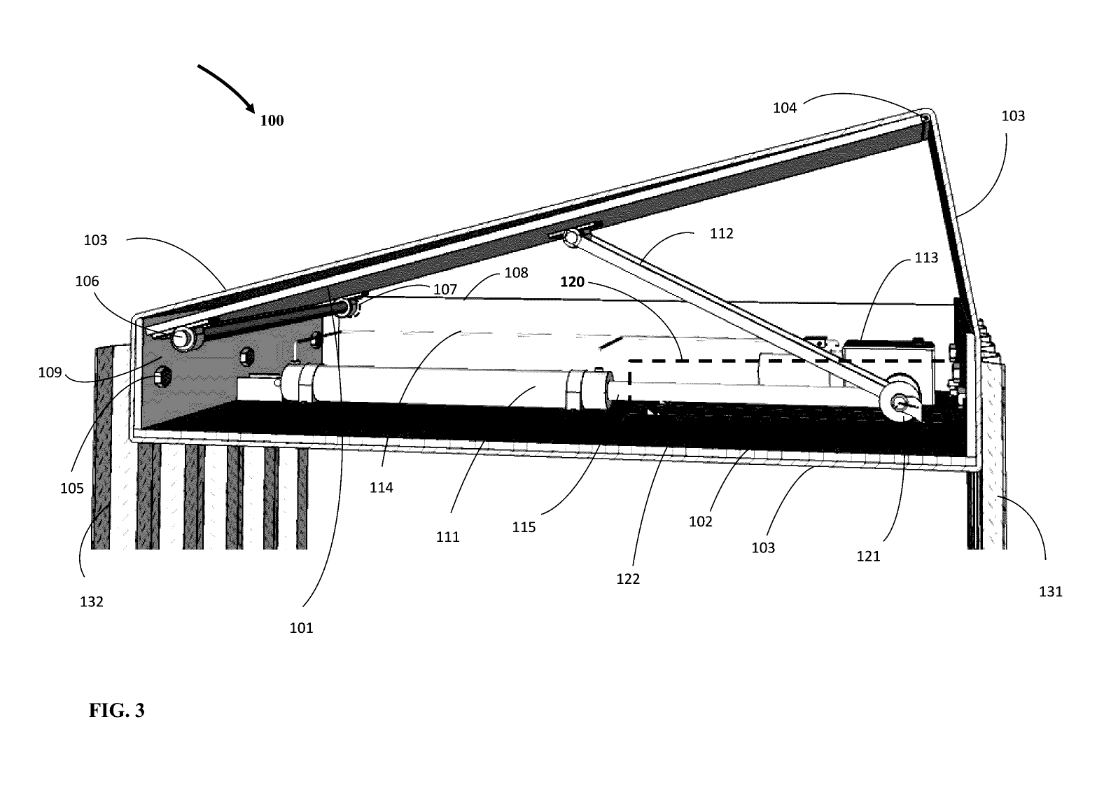

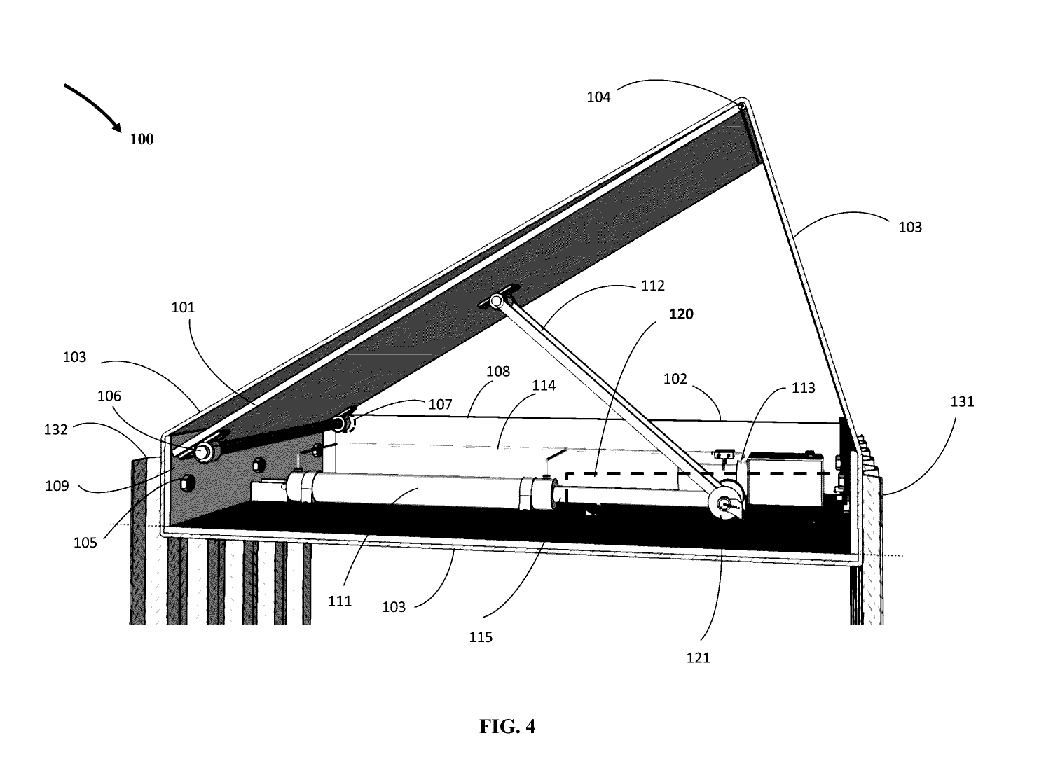

FIG. 3 shows a cross sectional view of an individual wicket gate device of present invention 100 with gate 101 raised to about one third of the way to the fully raised position. Electrical motor and hydraulic pump package 113 pressurize high pressure tubing 114 to push piston rod 115 inside cylinder 111 and pull wheel 121 in to push struts 112 and raise gate 101 up. Roller 104 at unhinged end of gate 101 enables elastomer 103 to stretch unhindered and cover over the backside of gate 101. FIG. 4 shows a cross sectional view of an individual wicket gate device of present invention 100 with gate 101 further raised to about two thirds of the way to the fully raised position. Electrical motor and hydraulic pump package 113 have further pressurized high pressure tubing 114 to push piston rod 115 inside cylinder 111 and pull wheel 121 in to push struts 112 and raise gate 101 up. Roller 104 at unhinged end of gate 101 has moved up, which has further stretched elastomer 103 maintaining its cover over the backside of gate 101.

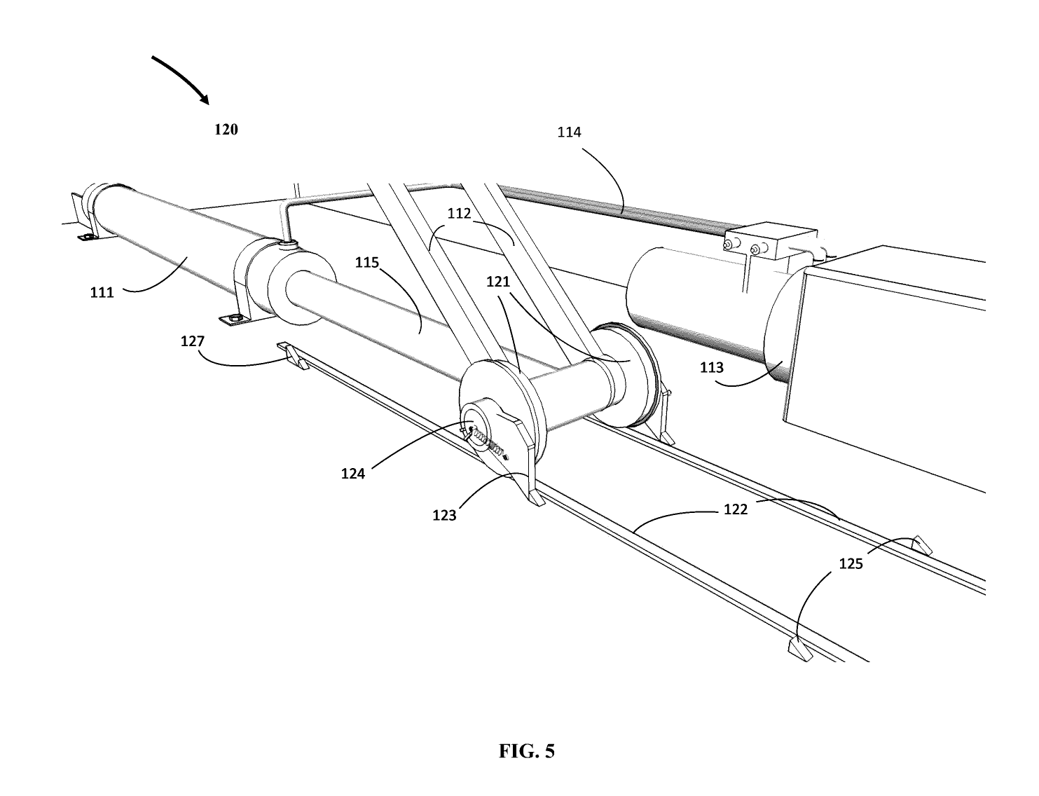

FIG. 5 is a close up perspective of the gate locking mechanism 120. Wheels 121 mounted on rod 124 move back and forth on horizontal rails 122 by piston rod 115 activated by hydraulic cylinder 111, which is powered by hydraulic motor and pump 113 via high pressure tubing 114. Spring loaded locking gears 123 engage with locking counter parts 125 to fix wheels 121 in position against the force exerted by struts 112 permitting power to be turned off

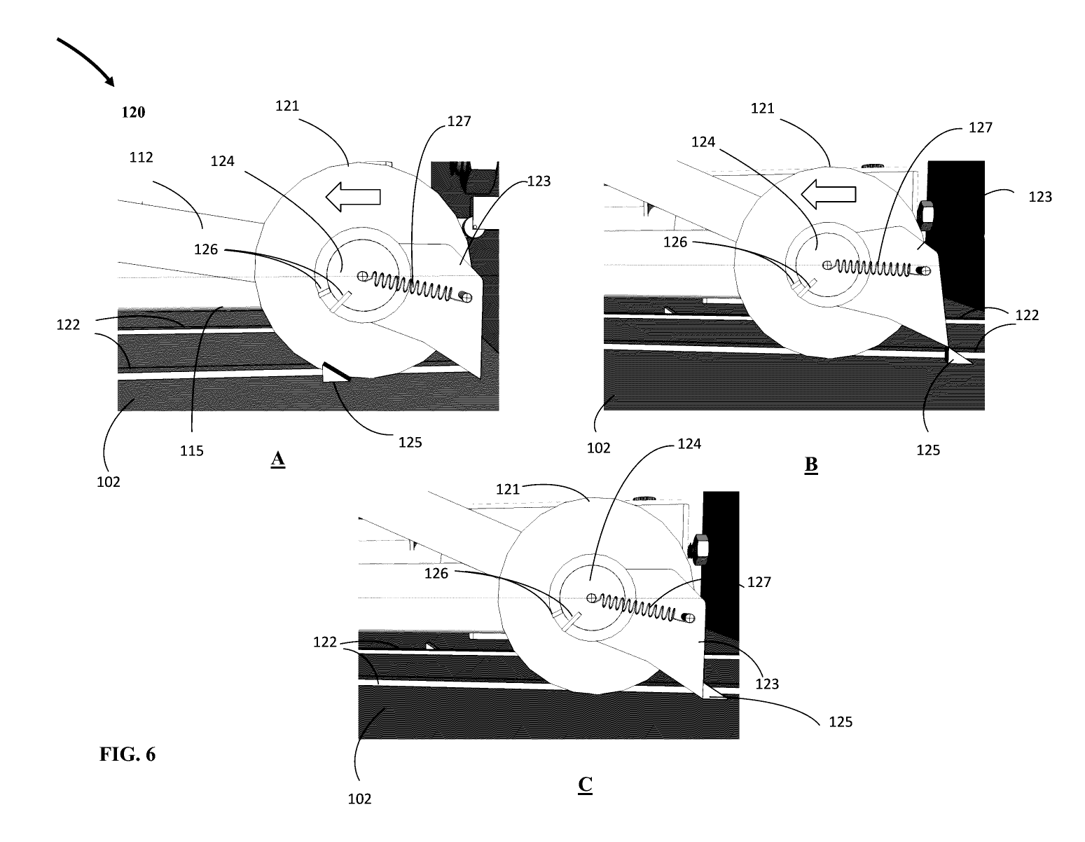

FIG. 6 shows the operational details of the gate locking mechanism 120 during gate raising. FIG. 6A shows the starting position of wheel 121 with the gate fully lowered at the onset of the gate being raised. Piston rod 115 pulls in rod 124 causing wheel 121 to rotate clockwise and roll on rails 122 pushing up strut 112 that raises the gate. Tensile spring 127 with one side attached to the center point of rod 124 and other side attached to locking gear 123 is below the centerline of rod 124 and pulls down on the locking gear 123. FIG. 6B shows locking gear 123 at highest point as it passes over locking counterpart 125. Locking gear 123 rotates clockwise as it passes over sloping backside of locking counterpart 125 while the connection point of tensile spring 127 to locking gear 123 remains below centerline of rod 124 such that tensile spring 127 pulls down on locking gear 123 at all times during passage over locking counterpart 125. FIG. 6C shows locking gear 123 following passage over locking counterpart 125. Tensile spring 127 maintains downward force on locking gear 123 exerting clockwise torque that is resisted by the floor of wicket gate device 102. Locking gear 123 engages with locking counterpart 125, which prevents wheel 121 from moving back thus keeping the raised gate in position allowing power to be turned off

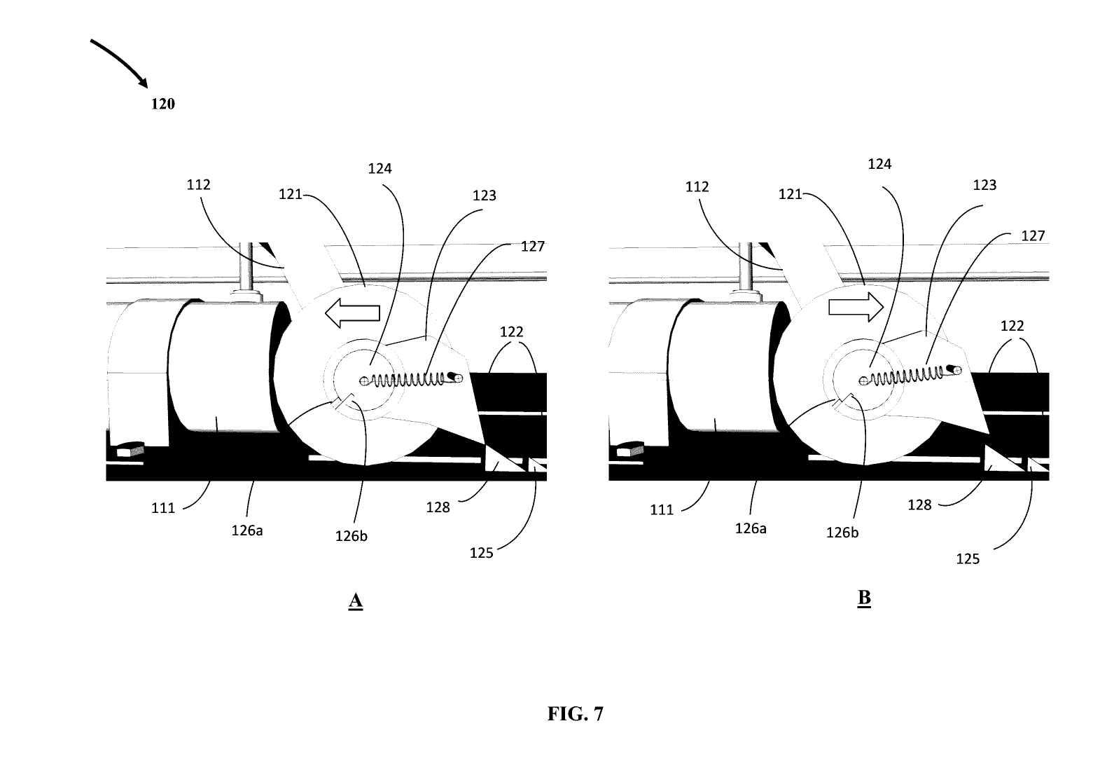

FIG. 7 shows the operational details of the gate locking mechanism 120 during gate lowering. FIG. 7A shows locking gear 123 passing over ramp 128, which is located passed locking counterpart 125 corresponding to the fully raised position of the gate. Ramp 128 is disposed to raise connection point of tensile spring 127 to locking gear 123 above centerline of rod 124 making tensile spring 127 pull up on locking gear 123 and exert an anticlockwise torque on locking gear 123. FIG. 7B shows the resting position of locking gear 123 with tensile spring 127 maintaining anticlockwise torque that is resisted by protrusion 126a on locking gear 123 pushing against protrusion 126b on rod 124. This position keeps locking gear 123 above locking counterparts 125 permitting the gate to be lowered back to its fully lowered position of FIG. 2 after the event.

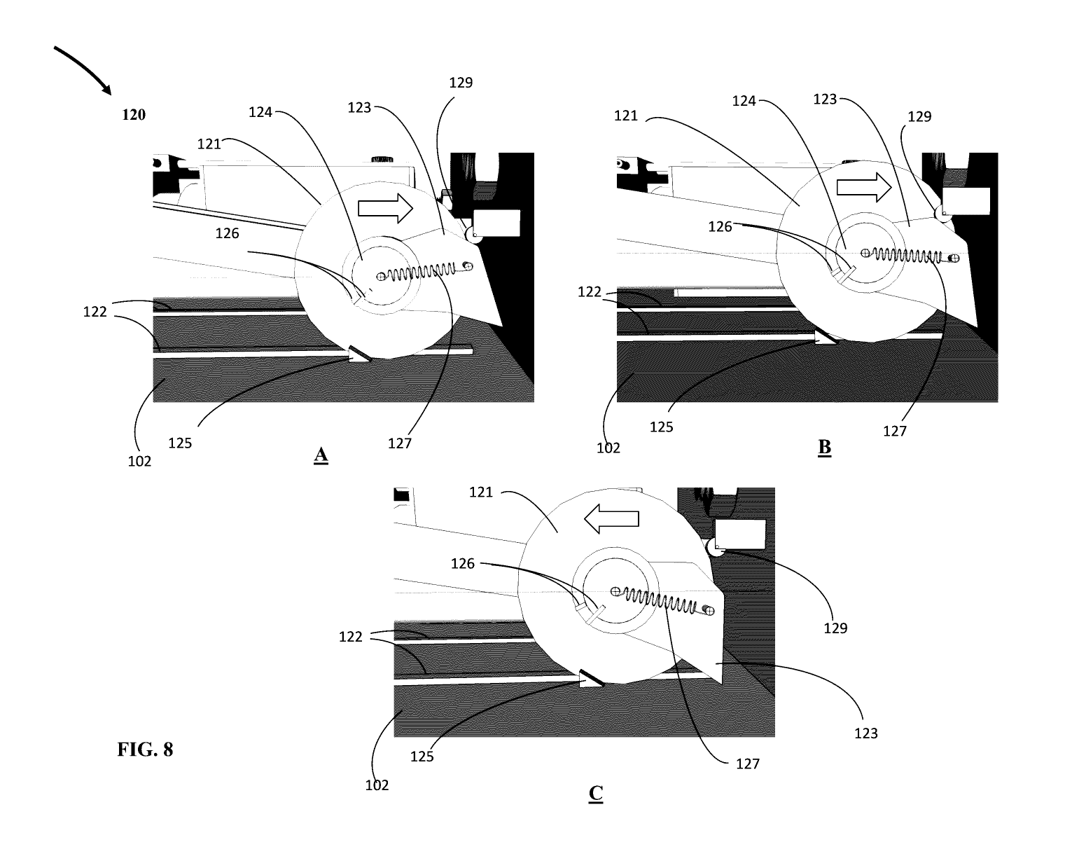

FIG. 8 shows the resetting of the gate locking mechanism 120 once the gate is completely lowered. FIG. 8A shows slanted top surface of locking gear 123 coming in contact with roller 129 as wheel 121 approaches the end of rails 122. FIG. 8B shows locking gear 123 being pushed down by roller 129 running on slanted surface of locking gear 123 to a point where connection point of tensile spring 127 to locking gear 123 falls below centerline of rod 124. Tensile spring 127 pulls down on locking gear 123 causing it to rotate clockwise. FIG. 8C shows resting position of locking gear 123 with torque exerted by tensile spring 127 on locking gear 123 being resisted by the floor of wicket gate device 102 returning it back to position shown in FIG. 6A, which is the starting position of wheel 121 with the gate fully lowered at the onset of the gate being raised.

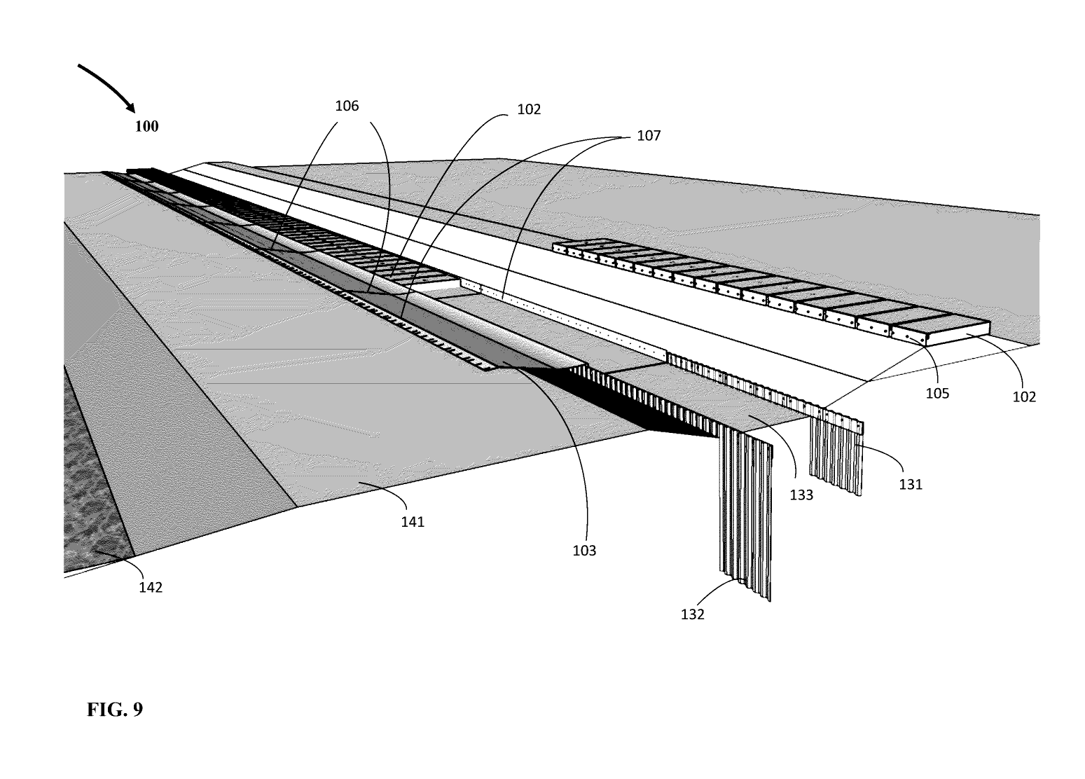

FIG. 9 is a perspective view of a typical construction site for the present invention 100. Longitudinal trench 133 is excavated substantially parallel to coastline 141 a certain distance inland from water 142, and is sized to fit the rectangular boxes 102. Upstream and downstream anchors such as parallel sheet piles 132 and 131 are driven into trench 133 an exact distance apart to fit the boxes 102 and elastomer 103, which may be furnished as longitudinal fitted sheets that are laid in trench 133 to form an impermeable bed against bottom surface of trench 133 and upstream and downstream sheet piles 132 and 131. Sheets of elastomer 103 ARE longitudinally attached and sealed at seams 106 by either chemical bonding or mechanical joints. Sheet piles 132 and 131 plus elastomer 103 may have pre-drilled holes 107 that align and corresponds to fasteners 105 on the boxes 102. Boxes 102 are placed on top of elastomer 103 inside trench 133 and remaining width of elastomer 103 is folded over and tucked in between rectangular boxes 102 and downstream sheet pile 131. Alternatively, a plurality of boxes 102 may be pre-assembled with elastomer 103 requiring only longitudinal attachment and sealing at seams 106 onsite. Boxes 102 are then fastened securely to sheet piles 132 and 131 by fasteners 105 through elastomer 103, and tightly sandwiched upstream and downstream between boxes 102 on one side and sheet piles 132 and 131 on the other. Trench 133 is then backfilled to bury the gate device 100 slightly below ground and restore coastline 141 to original conditions.

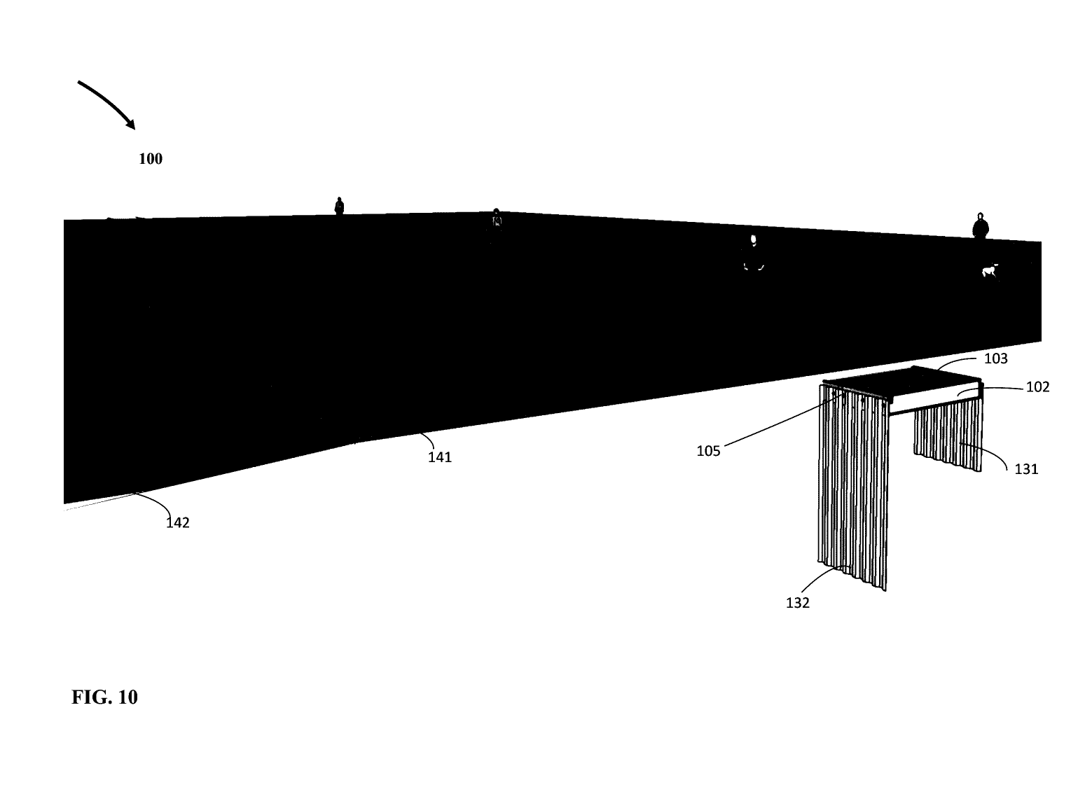

FIG. 10 shows the completed construction site with the moveable gate barricade constructed from a plurality of wicket gate devices of the present invention 100 in place. Coastline 141 is equipped with a moveable gate barricade in the form of wicket gate device rectangular boxes 102 that are fully wrapped inside elastomer 103 and securely fastened to upstream and downstream sheet piles 132 and 131 by fasteners 105. The moveable gate barricade constructed from a plurality of wicket gate devices of the present invention 100 is entirely below ground and causes no obstruction along coastline 141 and access to water front 142.

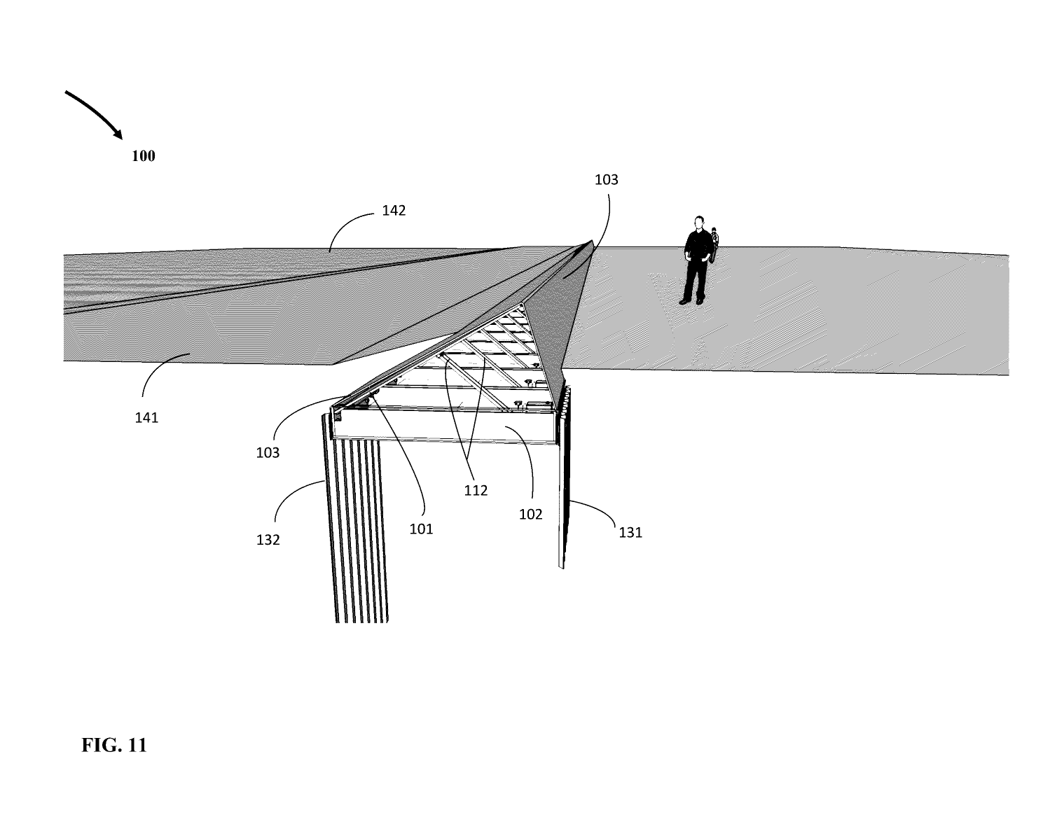

FIG. 11 shows the moveable gate barricade constructed from a plurality of wicket gate devices of the present invention 100 in partially raised position. Wicket gates 101 of individual device boxes 102 are pushed up by struts 112 to create a barrier along coastline 141 and provide protection against rise in level of water 142. Elastomer 103 is stretched by the raising of gates 101 and fully covers the backside of the moveable gate device 100. The tension in elastomer 103 provides a taught protective surface that slopes steeply from the gates 101 such that sand and debris objects cannot enter inside or accumulate on it to interfere with the operation of the wicket gate device 100.

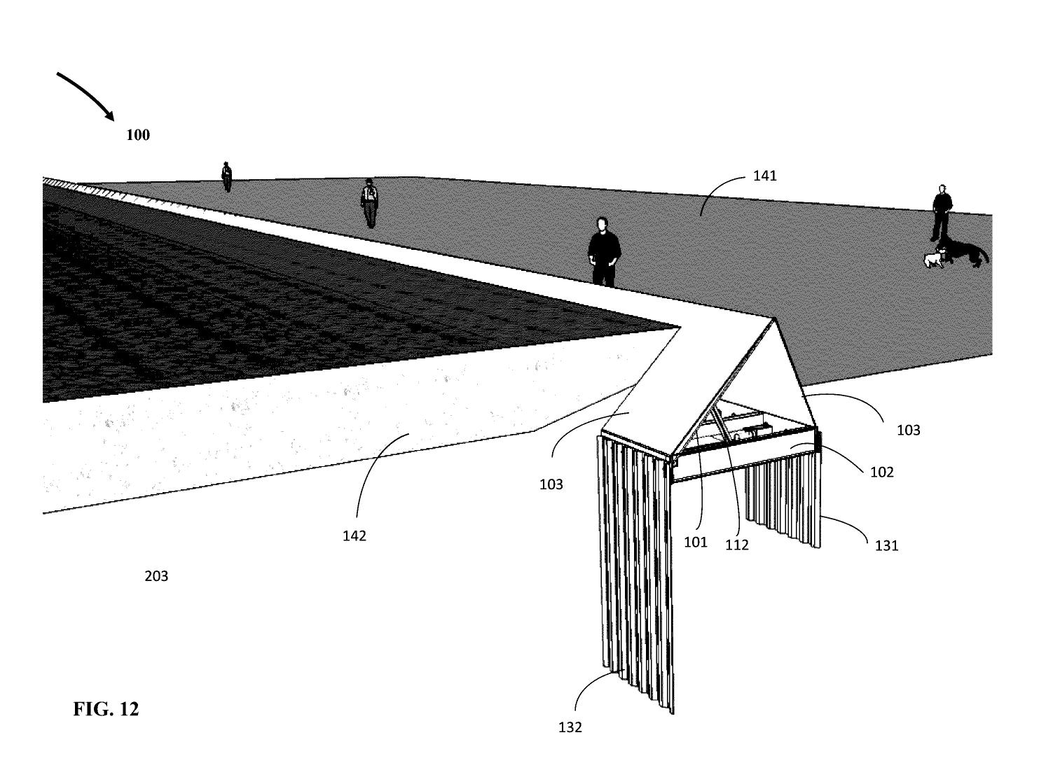

FIG. 12 shows the moveable gate barricade constructed from a plurality of wicket gate devices of the present invention 100 in fully raised position providing protection against flooding by elevated water 142. Elastomer 103 is fully stretched per design and at maximum tension making its protective surface most taught. Gate device 100 is at maximum height and can thus protect fully against anticipated rise in water level 142. Moveable gate devices 100 may be designed to withstand overtopping such that rise in level of water 142 in excess of maximum height would not cause structural damage. Struts 112 are locked in place by mechanism shown in FIG. 6 propping up gates 101 and power to gate device 100 is turned off. Gate device 100 stays raised until water level 142 has subsided at which time it can be lowered with elastomer 103 contracting to revert back to fully lowered position shown in FIG. 10. Following each event, coastline 141 may require minor earth work in covering over the gate device to fully restore to pre-event conditions.

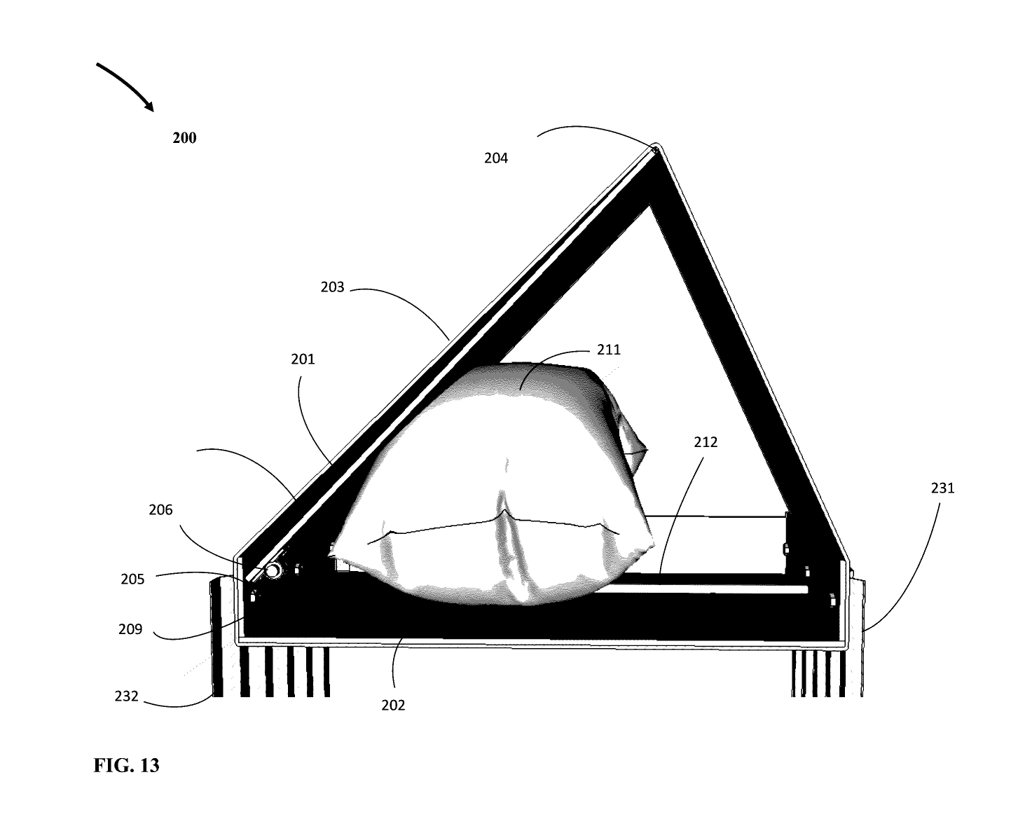

FIG. 13, shows a cross sectional view of an individual wicket gate device of another embodiment of the present invention 200 using pneumatic operating system. Wicket gate device 200 is comprised of wicket gate 201 shown in fully raised position, structural box 202 made from metal, concrete, or plastic, having a wicket gate 201 mounted on rod 206 that spans the width of box 202 supported at either end by bearings near the top corner adjacent to upstream end 209, such that wicket gate 201 serves as the flip-open lid of box 202. Structural box 202 is fitted with a pneumatic operating system comprised of an inflatable bladder 211 and high pressure tubing 212 connected to and external pressurization source (not shown). Stretchable elastomer 203 forms an impermeable cover over the air gaps between stationary and moveable components of each device as well as the air gaps between adjacent devices, thus sealing and protecting against external elements. Wicket gate 201 is raised to desired level by inflating bladder 211 to certain pressure controlled by the duration of pressurization. The raising of gate 201 exerts a tensile force on elastomer 203 at roller 204 on the unhinged end of wicket gate 201, which uniformly stretches elastomer 203. Fasteners 205 secure structural box 202 to anchors such as sheet piles 232 and 231 on both upstream and downstream sides. Tension in elastomer 203 maintains positive downward force on bladder 211 at all times during operation providing for passive depressurization of bladder 211 during lowering of wicket gate 201.

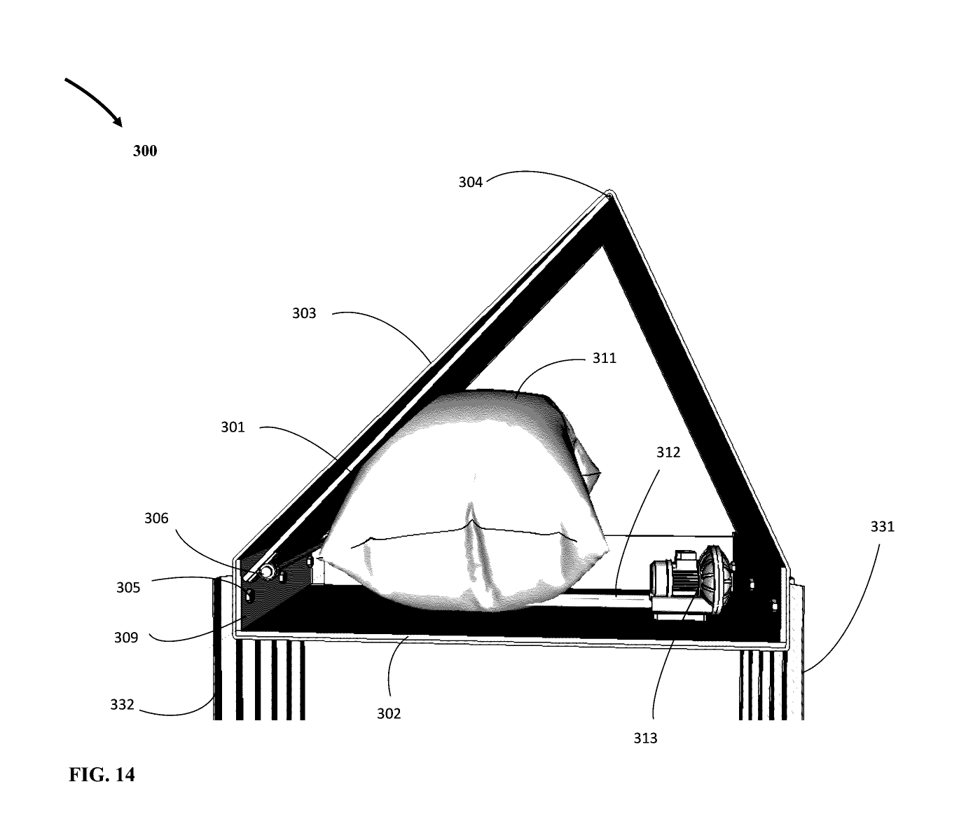

FIG. 14, shows a cross sectional view of an individual wicket gate device of another embodiment of the present invention 300 using pneumatic operating system. Wicket gate device 300 is comprised of wicket gate 301 shown in fully raised position, structural box 302 made from metal, concrete, or plastic, having a wicket gate 301 mounted on rod 306 that spans the width of box 302 supported at either end by bearings near the top corner adjacent to upstream end 309, such that wicket gate 301 serving as the flip-open lid of box 302. Structural box 302 is fitted with a pneumatic operating system comprised of inflatable bladder 311 and high pressure tubing 312 and inflation/deflation air pump 313 for that device. Stretchable elastomer 303 forms an impermeable cover over the air gaps between stationary and moveable components of each device as well as the air gaps between adjacent devices, thus sealing and protecting against external elements. Wicket gate 301 is raised to desired level by inflating bladder 311 to certain pressure controlled by the duration of pressurization by air pump 313. The raising of wicket gate 301 exerts a tensile force on elastomer 303 at roller 304 on the unhinged end of wicket gate 301, which uniformly stretches elastomer 303. Fasteners 305 secure structural box 302 to anchors such as sheet piles 332 and 331 on both upstream and downstream sides. Tension in elastomer 303 maintains positive downward force on bladder 311 at all times during operation providing for passive depressurization of bladder 311, which may be assisted with air pump 313 working in reverse to actively extract air from bladder 311 during gate lowering. Electrical power to air pump 213 is provided with an external cord (not shown).

There is little practical difference in the assembly and construction procedures of embodiments of the present invention using pneumatic operating system shown in FIG. 13 200 and FIG. 14 300, and the embodiment of the present invention using hydraulic operating system shown in FIG. 1 100. These embodiments may be constructed in the same manner shown in FIGS. 9 and 10 and protect in the manner shown in FIGS. 11 and 12.

The present invention is susceptible to modifications and variations which may be introduced thereto without departing from the inventive concepts and the object of the invention. Mechanisms other than those described may be employed to accomplish the main object of the present invention, which is to raise a wicket gate inside a stretchable elastomer in order to provide a moveable gate barrier that can protect against intruding seawater and floodwaters without creating a physical and visual obstruction to and from the waterfront during normal times. For example, the arrangement of wheels running on rails to support the strut may be replaced with a sliding mechanism using encased ball bearings on guides such as is common in the art and the locking mechanism modified accordingly. The inflatable bladder may be replaced with inflatable bellows or similar The individual wicket gate devices may be all pre-fabricated or alternatively assembled on site. The anchors serving as foundation of the moveable gate barrier might be sheet piles as shown or cast in place reinforced concrete. Such modifications and variations are within the invention concepts.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A power operated wicket gate device having a structural box containing a hydraulic operating system which operates a wicket gate disposed to constitute the top surface of said structural box when in fully lowered position supporting traffic loads from above, and assume a number of predetermined angular positions about a horizontal shaft attached to said structural box, said operating system comprising:
strut hinged at the underside of said wicket gate at one end disposed to prop said wicket gate at a multitude of angles corresponding to different flood protection levels and other extremity pivotally supported on wheels running on horizontal rails on the floor of said structural box with movement of said wheels on said rails changing the prop angle of said wicket gate enabling said wicket gate to be lowered and raised;
a hydraulic cylinder and piston horizontally mounted and fixed to the floor of said structural box, said cylinder and piston having an operating rod attached to said wheels enabling controlled movement of said wheels on said rails to lower and raise said wicket gate,
a hydraulic power system that powers said hydraulic cylinder and piston, said hydraulic power system comprised of an electrical motor connected to a hydraulic pump in communication with hydraulic fluid,
a locking mechanism disposed to secure said wheels in place at predetermined positions allowing said wicket gate to stay raised at said predetermined angular positions with power turned off, said locking mechanism snapping to unlocked position once said wicket gate is raised passed maximum height permitting lowering of said wicket gate, and snapping back to locking position once said wicket gate is fully closed,
an external cord that supplies electrical power to said wicket gate assembly.

2. Wicket gate device according to claim 1 further comprising an impermeable and stretchable elastomer that covers over the gaps between said wicket gate and said structural box throughout raising and lowering of said wicket gate as well as the gaps between a plurality of said wicket gate assemblies when placed side by side to form a moveable gate barricade of certain length, said impermeable and stretchable elastomer sealing and protecting from external elements while stretching and contracting with the raising and lowering of said wicket gates comprising said moveable gate barricade.

3. Moveable gate barricade according to claim 2 further comprising a trench disposed to house said moveable gate barricade below grade, said trench equipped with anchors that serve as foundation securing said wicket gate devices in place providing adequate resistance against external forces.

4. Wicket gate device of claim 1 wherein said wheels running on rails is replaced with sliding mechanism using encased ball bearings on guides.

5. Wicket gate device of claim 1 wherein said hydraulic operating system is replaced with a pneumatic operating system comprising:
an inflatable bladder supported on the floor of said structural box disposed to push against and raise said wicket gate when pressurized and inflated, the extent of raising of said gate being directly proportional to the extend and magnitude of pressurization of said inflatable bladder;
pressure tubing disposed to pressurize and depressurize said inflatable bladder by means of pushing air in and allowing air out respectively, said pressure tubing connected to an external air pressurization device plus an air vent serving as means of pressurization/depressurization of said inflatable bladder.

6. Wicket gate device of claim 5 wherein said pressure tubing is connected to an electrical air inflow/extraction pump disposed to pressurize/depressurize said inflatable bladder, said pump connected to an external power supply via an electrical cord.

7. Wicket gate device of claim 5 wherein said inflatable bladder is replaced with inflatable bellows.
